(19) United States
(12) Patent Application Publication
(10) Pub. No.: US 2010/0133214 A1
(43) Pub. Date: Jun. 3, 2010

(54) DISPLAY UNIT WITH ROLLER ASSEMBLY SHELVING

(75) Inventor: David William Evans, Castle Hill (AU)

Correspondence Address: DANIEL B. SCHEIN, PH.D., ESQ., INC., P. O. BOX 68128, Virginia Beach, VA, 23471, US

(73) Assignee: HAMLON PTY LTD, Frenchs Forest, NS (AU)

(21) Appl. No.: 12/598,575

(22) PCT Filed: Feb. 6, 2009
(86) PCT No.: PCT/AU2009/000136

§ 371 Date: Dec. 16, 2009

Related U.S. Application Data
(60) Provisional application No. 61/118,071, filed on Nov. 26, 2008.

(30) Foreign Application Priority Data
Feb. 8, 2008 (AU) 2008900584
Apr. 7, 2008 (AU) 2008901624

(51) Int. Cl. A47F 7/00; A47F 5/00; B65G 13/00

(52) U.S. Cl. 211/85.8; 211/49.1; 211/183; 193/37

(57) ABSTRACT

A roller assembly for use with a commodity display unit, the roller assembly comprising at least one set of parallel rollers mounted on an inner casing. Each roller is a stub roller with a stub at each end, and the inner casing has opposed side walls projecting from a base. Each side wall having a series of notches at its upper free end for respectively receiving the stubs of the stub rollers, and the inner casing with the rollers mounted thereon slidably engagable within an outer casing such that the stub rollers are restrained from being removed from their respective notches by two inwardly projecting upper flanges of the outer casing. Each upper flange projects from a respective wall member of the outer casing. The inner casing is secured within the outer casing by two end caps, each slidable engagable with the outer casing at opposed ends thereof.

### TECHNICAL FIELD

The present invention relates to product display units having shelves that include one or more rollers to facilitate product movement on the shelves. In particular, the present invention is directed to display units and shelving therefor in which a plurality of roller assemblies are aligned in a plane and can interact with product dividers and/or other shelving features, such as a front riser, to facilitate optimum displaying and dispensing of products in retail markets and elsewhere.

### BACKGROUND

In conventional display units with shelving it is known to move product to the front of a shelf by various means. One known arrangement is to utilise gravity feed roller assemblies in shelving display units to facilitate product movement from the rear to the front. Examples of such roller assembly shelving can be seen in the disclosures of U.S. patents, such as U.S. Pat. No. 6,089,385 to Nozawa, U.S. Pat. No. 6,409,026 to Watanabe and U.S. Pat. No. 6,497,326 to Osawa. Another roller assembly (track) system is that distributed by HL Display AB of Sweden, which is adapted to be placed on a conventional retail shelf. Such roller assembly (or track) systems can be disposed at a small angle slope in to order to use gravity to bias the product at the rear of the shelf to move forward as the foremost product is removed. Disadvantage of prior art roller assemblies is that they are generally suited to single or limited display unit applications, are generally complex and/or costly to manufacture, and/or are designed to be mounted on existing shelving rather than to replace prior art shelving. Prior art display units using roller shelving are heavier or larger than desired, interfere with view of the products displayed, and are inefficient in use of materials, inter alia.

Such shelving display units with roller assembles utilise a front riser to prevent the product from falling off the front of the shelf. In many instances the “riser” is removably clipped to the assembly, and not adequately secured. In general use, such a riser may be removed accidentally by customers or retail staff, allowing products to slide off the shelf, thereby posing a safety issue and potentially damaging the product. Whilst such a problem could be overcome by making the riser integrally part of the roller assembly frame or secured thereto by hard to remove fasteners, this would cause other problems. The risers are prone to damage and wear and tear, and must be able to be readily replaced by retail staff.

Therefore, an object of the present invention is to provide a roller assembly suitable for use in display units that will overcome or substantially ameliorate one or more of the deficiencies of the prior art and provide a useful alternative thereto. The present invention may provide a display unit and/or shelving therefore that moves product(s) to the front of shelves supporting same, while also minimizing shelving components at the front of the shelves that interfere with view of the products while also preventing the products from unintentional spilling off the front edge of the shelves. Ideally, products should be highly visible on each shelf, products should be easy for the target consumer to remove, as each product is removed another product should automatically move into its place (e.g., the display/shelve should act as an “automatic product mover” or “APM”), and shelving components may also help draw attention to the displayed products and/or inform the target consumers about the product and/or sale terms and special offers. Preferably, shelving components that are soiled or worn during use and/or components that may require updating should be easy to replace and/or to remove and reinstall after cleaning and/or updating. Other advantages of the present invention arise from the following description, such as but not limited to more compact and multifunctional shelving components that reduce materials used, while providing a more attractive overall product display unit.

### SUMMARY OF THE INVENTION

In a first aspect the present invention consists in a roller assembly for use with a commodity display unit, said roller assembly comprising at least one set of parallel rollers mounted on an inner casing, wherein each roller of said parallel set of rollers is a stub roller with a stub at each end, and said inner casing has opposed side walls projecting from a base, each side wall having a series of notches at its upper free end for respectively receiving the stubs of said stub rollers, said inner casing with said rollers mounted thereon slidably engagable within an outer casing such that the stub rollers are restrained from being removed from their respective notches by two inwardly projecting upper flanges of said the outer casing, each upper flange projecting from a respective wall member of said outer casing, and wherein said inner casing is secured within said outer casing by two end caps, each slidable engagable with said outer casing at opposed ends thereof.

Preferably said base of said inner casing having a plurality of apertures disposed therein.

Preferably each roller and said inner casing is made of injection moulded plastic.

Preferably said outer casing has a plurality of apertures disposed within its underside.

Preferably said outer casing is of extruded metallic material and said apertures are cut-outs.

Preferably each end cap is provided with a plurality of apertures.

Preferably a divider element may be secured to said roller assembly by engaging with the end caps.

Preferably said divider element engages with at least one of said plurality of apertures in each respective end cap.

Preferably each end cap is made of injection moulded plastic.

Preferably each end cap is secured to the outer casing by at least one threaded fastener.

In a first embodiment a shelving display unit comprises an array of roller assemblies, each roller assembly being of the type described in the abovementioned first aspect of invention. Said array of roller assemblies disposed adjacent to one another, each of said roller assemblies having a first longitudinal axis inclined from the rear to the front of the unit such that product supported by said roller assemblies may travel by gravity feed from the rear to the front of the unit.

Preferably a front rail with a longitudinal channel of constant dimensions is slidably engageable with the end caps at the front of the unit.

In a second embodiment a mobile shelving display unit comprises an array of roller assemblies, each roller assembly being of the type described in the abovementioned first aspect of invention. Said array of roller assemblies disposed adjacent to one another, each of said roller assemblies having a first longitudinal axis inclined from the rear to the front of the unit such that product supported by said roller assemblies may travel by gravity feed from the rear to the front of the unit.

In a second aspect the present invention consists in a product display unit, said unit comprising at least one shelf, said at least one shelf comprising a retaining member for holding at least two roller track assemblies in alignment to form a planar product support surface, said retaining member comprising a first retaining channel for engaging a portion of at least two roller track assemblies, said retaining member comprising a second retaining channel for engaging at least one product stop member, wherein said second retaining channel is positioned with respect to said first retaining channel so as to direct a product stop member engaged with said second retaining channel to project above the plane of the product support surface formed by roller track assemblies engaged with said first retaining channel so as to be able to engage a product resting on a planar product support surface formed by at least two roller track assemblies aligned by engagement with said first retaining channel.

In a third aspect the present invention consists in retaining member for use in forming a shelf for a product display unit, said retaining member for holding at least two roller track assemblies in alignment to form a planar product support surface, said retaining member comprising a first retaining channel for engaging a portion of at least two roller track assemblies, said retaining member comprising a second retaining channel for engaging at least one product stop member, wherein said second retaining channel is positioned with respect to said first retaining channel so as to direct a product stop member engaged with said second retaining channel to project above the plane of the product support surface formed by roller track assemblies engaged with said first retaining channel so as to be able to engage a product resting on a planar product support surface formed by at least two roller track assemblies aligned by engagement with said first retaining channel.

Preferably said retaining member further comprising at least two roller track assemblies engaged therewith to form a shelving unit.

In a fourth aspect the present invention consist in a mobile shelving assembly comprising a support frame supporting a plurality of spaced apart shelves, said support frame having a plurality of ground engaging wheels, at least one of said shelves having an array of inclined roller assemblies, each roller assembly having at least one set of parallel rollers mounted on an inner casing slidably engagable within an outer casing, wherein said outer casing has a plurality of apertures disposed within its underside.

Preferably each roller of said parallel set of rollers is a stub roller with stubs on each side, said inner casing has opposed side walls, each side wall having a series of notches for respectively receiving the stubs of said stub rollers.

Preferably said outer casing is of extruded material and said apertures are cut-outs.

Preferably said array of inclined roller assemblies may be disposed adjacent to each other or adjusted at spaced apart increments.

Preferably each of said shelves has a front riser.

Preferably said support frame has a plurality of frame uprights, each frame upright has a plurality of holes therein for the vertical adjustment of shelf height.

Preferably at least two handles project rearwardly and inwardly from said support frame, each handle associated with a respective frame upright. Preferably said plurality of frame uprights are bolted to top and bottom frame sections of said support frame.

Preferably a drip tray can be removably secured to the base of said support frame.

Preferably said ground engaging wheels are castor wheels. Preferably two of the castor wheels are lockable rear castor wheels.

### BRIEF DESCRIPTION OF DRAWINGS

FIG. 1 is an upper perspective view of a first embodiment of a roller assembly of the present invention together with unattached divider.

FIG. 2 is an exploded upper perspective view of the components of the roller assembly shown in FIG. 1, together with unattached divider.

FIG. 3 is an enlarged perspective view of a roller being a component of the roller assembly shown in FIG. 1.

FIG. 4 is an enlarged perspective view of an inner casing component of the roller assembly shown in FIG. 1.

FIG. 5 is an enlarged perspective view of an outer casing component of the roller assembly shown in FIG. 1.

FIG. 6 is an enlarged perspective view of an end cap component of the roller assembly shown in FIG. 1.

FIG. 7 is an exploded upper perspective view of a shelf for a display unit comprising an array of roller assemblies of the type shown in FIG. 1, in side by side relationship.

FIG. 8 is an enlarged perspective view of a front corner of the shelving display unit, with the riser slidably moved relative to the front rail.

FIG. 9 is an enlarged side view of the front corner the shelving display unit shown in FIG. 8.

FIG. 10 is a perspective view of a first embodiment of a mobile shelving assembly of the present invention.

FIG. 11 is a front view of the mobile shelving assembly shown in FIG. 10.

FIG. 12 is a side view of the mobile shelving assembly shown in FIG. 10.

FIG. 13 is a top view of the mobile shelving assembly shown in FIG. 10.

### MODE FOR CARRYING OUT THE INVENTION

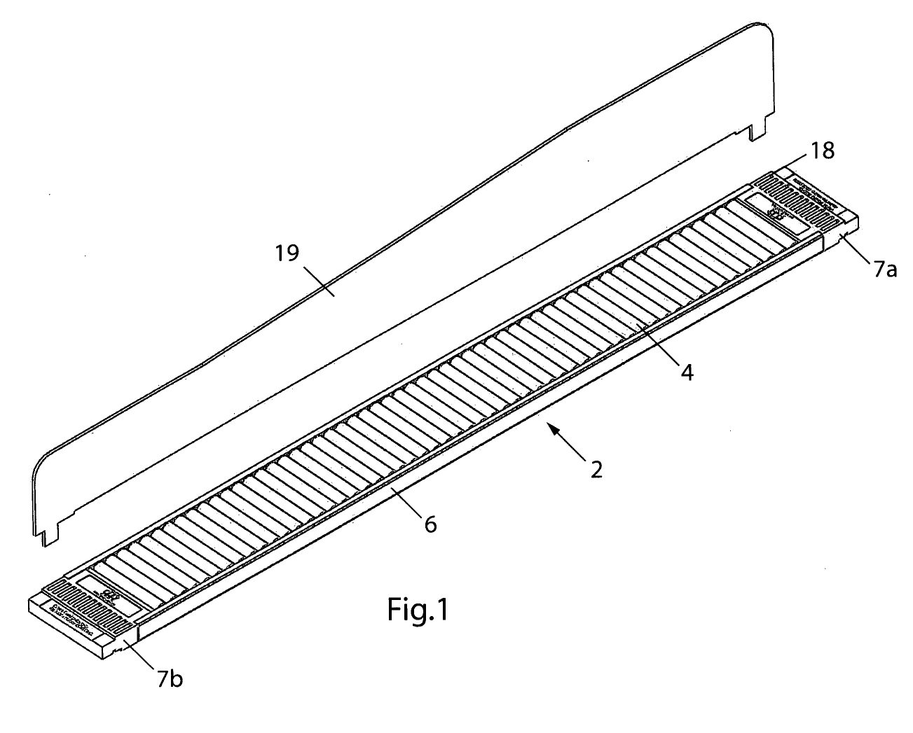

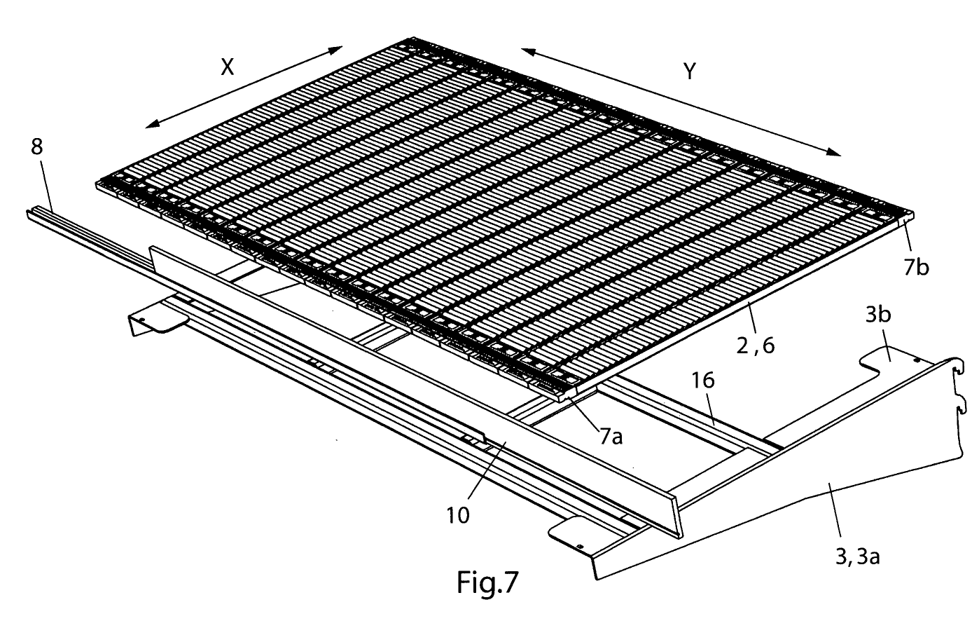

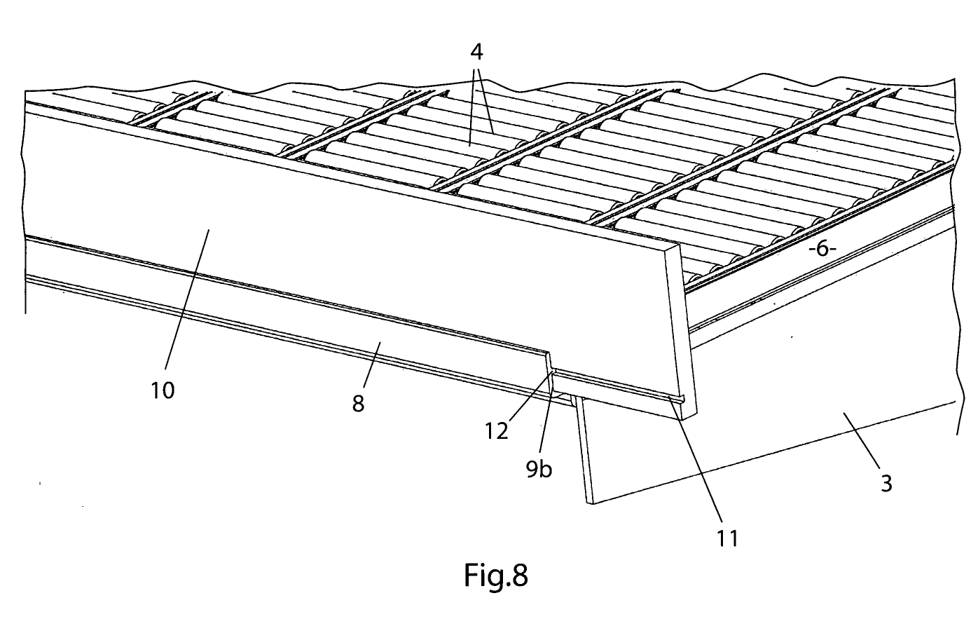

FIGS. 1 to 6 depict a roller assembly 2 in accordance with a first embodiment of the present invention. An array of such roller assemblies 2 may be used in side by side relationship to form a shelving display unit or a shelf unit 1 as shown in FIGS. 7 to 9, preferably for use in supermarket, convenience, liquor store or other retail applications.

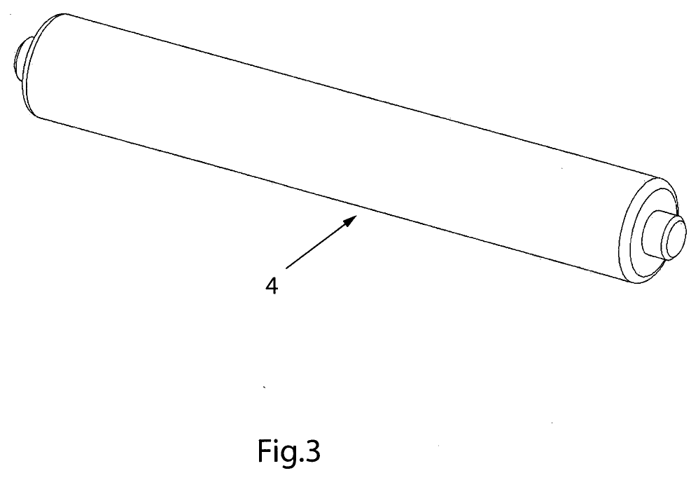

Roller assembly or “roller track” 2 comprises a set of parallel stub rollers 4 mounted on an inner casing 5 slidably engagable with an outer casing 6. The stubs 14 of rollers 4 are seated in notches 50 disposed on the sidewalls 51 of the inner casing 5 in a similar fashion to that shown in FIG. 3 of the prior mentioned U.S. Pat. No. 6,089,385 to Nozawa.

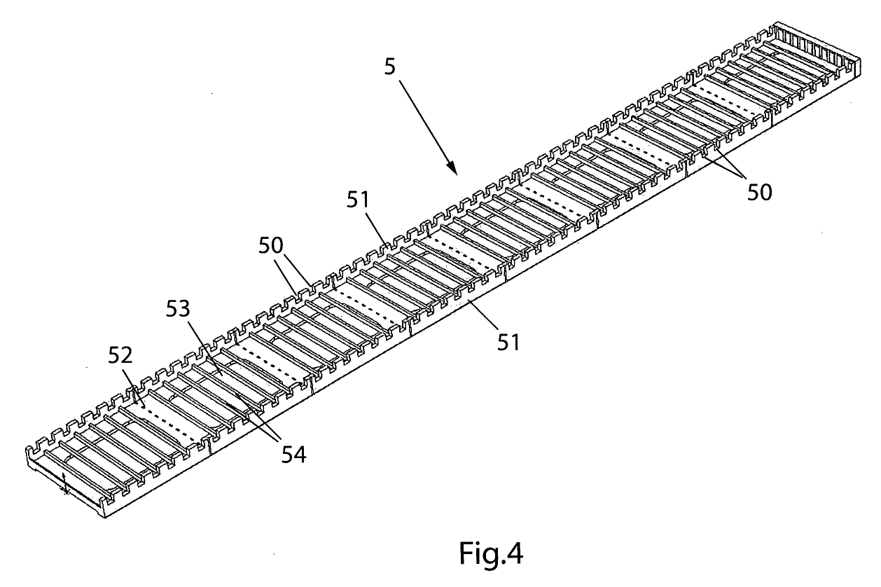

As shown in FIG. 4, inner casing 5 has a base 52 having a plurality of apertures 53 therein, and a plurality of stiffening ribs 54 spanning the apertures 53.

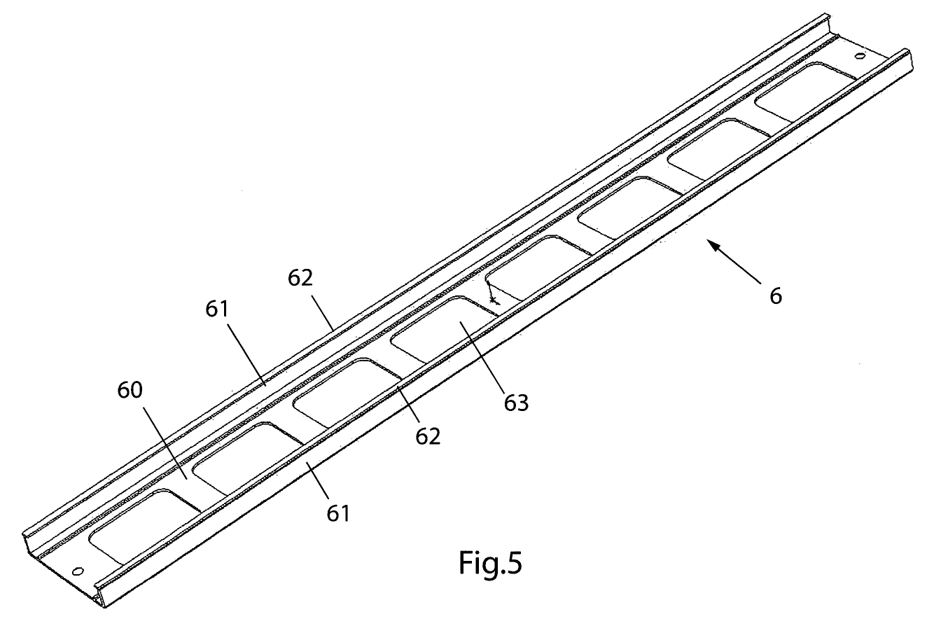

As shown in FIG. 5, outer casing 6 has an underside member (base) 60 from which two side members (walls) 61 upwardly project. Inwardly projecting flanges 62 project respectively from each side member 61. The underside member 60 has a plurality of apertures 63 therein.

When inner casing 5 is slidably engaged in a longitudinal direction with outer casing 6, the rollers 4 seated in notches 50, are kept in place by the outer casing 6. This is because the inwardly projecting flanges 62 on respective side members 61, restrain the stubs of rollers 4 from being removed from their respective notches 50.

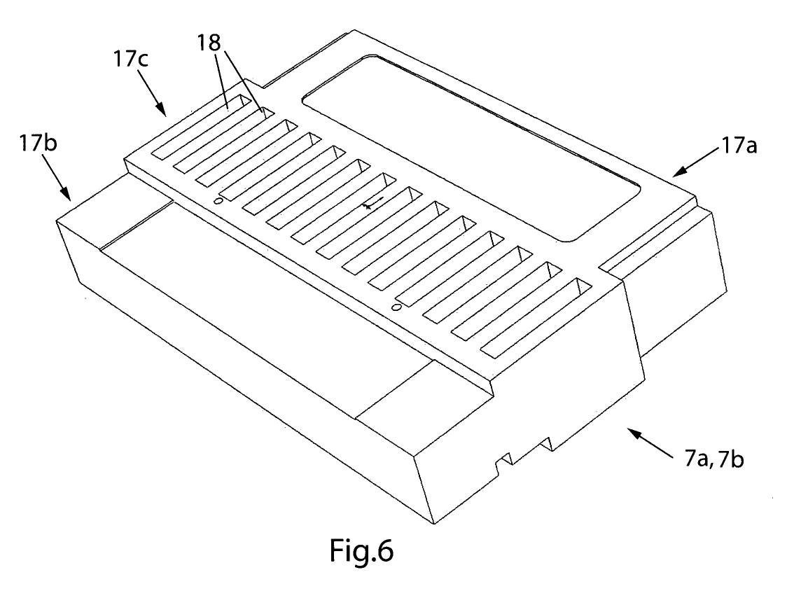

The inner casing 5 is secured within outer casing 6 by front end cap 7a and rear end cap 7b. As shown in FIG. 6, each end cap 7a, 7b has a first end 17a, a second end 17b and a middle portion 17c disposed therebetween. First end 17a is keyed to enable it to slidably engage into an end of outer casing 6. Threaded fastener apertures 64 are provided in outer casing 6, so that a threaded fastener such as a screw (not shown) may be used to secure the first end 17a of respective end cap 7a/7b to the outer casing 6. The middle portion 17c of each end cap 7a, 7b has a plurality (an array) of apertures 18 disposed thereon. Apertures 18 in each end cap 7a, 7b allow for attachment of a divider element 19, or other component such as a guide member for guiding product to roller assembly 2.

In this embodiment front end cap 7a and rear end cap 7b, are identical. However, it should be understood that in other not shown embodiments they may differ in shape and configuration.

Preferably outer casing 6 is made of an extruded metal such as aluminium, with apertures 63 cut out. Whilst inner casing 5, rollers 4, and end caps 7a, 7b are all preferably made of injection moulded plastic.

Display shelf unit 1 as shown in FIGS. 7 to 9, comprises an array of roller assemblies 2 arranged so that they are adjacent to each other, with each roller assembly disposed longitudinally from rear to front, parallel to axis X. They are supported by a frame 16 that extends between the horizontal members 3b of brackets 3.

Unit 1 is provided with brackets 3 at each end thereof, which allows the shelf unit 1 to be attached to conventional vertical shelf support members (not shown). Each of brackets 3 includes a vertical member 3a and horizontal member 3b.

In use when shelf unit 1 is fitted to conventional vertical shelf support members, the roller assemblies 2 are inclined downwardly from the rear to front of the unit 1, so that retail product, which may be loaded from the rear of the unit, is moved to the front of the unit 1 under the influence of gravity.

The front end caps 7a of the respective roller assemblies 2 are aligned. A front rail (retaining member) 8 preferably made of an extruded metal material of constant cross section, is used to slidably engage with the end caps 7a. Front rail 8 has two longitudinal retaining channels 9a and 9b whose openings are arranged at 90 degrees (right angles) to each other. First retaining channel 9a of the front rail 8 is used to slidably engage with the free end of aligned end caps 7a, thereby securably maintaining the alignment of the roller assemblies 2 (this may also be referred to as a slide lock mechanism for the end caps to prevent them from moving with respect to each other). In this embodiment end caps 7a have a groove 13 that engages with an elongate projection 14 within channel 9a on front rail 8.

When front rail 8 is secured to roller assemblies 2, the longitudinal channels 9a and 9b each have a longitudinal axis, parallel to axis Y.

A riser 10, i.e., product stop, is used to ensure that product moving to the front of unit 1 does not fall off. Riser 10 is removably attached to front rail 8.

In this embodiment riser 10 is slidably engagable to the second retaining channel 9b, such that the riser 10 is parallel to axis Y. In this embodiment the riser 10 has a groove 11 that engages with an elongate projection 12 within channel 9b on front rail 8.

As the engagement and disengagement of riser 10 from front rail 8 must occur by movement along channel 9b (parallel to axis Y), the urging of product against riser 10 or the pulling or bumping of the riser from the front cannot cause it to disengage from unit 1. As such, it is extremely difficult to remove riser 10 from front rail 8 when the shelf unit 1 is attached to conventional vertical shelf support members. This ensures that product supported on shelf unit 1 can be safely held and minimize the risk of damage to the product and injury to workers and shoppers.

Thus, there has been disclosed an assembly comprising a front rail (retaining member) 8, for use in forming a shelf for a product display unit, wherein rail 8 is for holding at least two roller assemblies 2 in alignment to form a planar product support surface. The rail 8 comprises first retaining channel 9a for engaging a portion of at least two roller track assemblies 2, and further comprises second retaining channel 9b for engaging at least one riser (product stop member) 10. The second retaining channel 9b is positioned with respect to the first retaining channel 9a, so as to direct riser 10 engaged with the channel 9b to project above the plane of the product support surface formed by roller assemblies 2 engaged with the retaining channel 9a, so as to be able to engage a product resting on a planar product support surface formed by at least two roller track assemblies 2 aligned by engagement with retaining channel 9a. Embodiments of the present inventions include a shelve incorporating the front rail 8 as well as a display unit incorporating at least one shelve incorporating the front rail 8. Variations may be made to the external ornamental appearance of rail 8 and/or risers 10 used therewith to customize the appearance for particular products and uses. The ornamental appearance of rail 8 will also affect the overall ornamental appearance of shelving and display units incorporating same.

The riser (product stop) 10 can be transparent or translucent to minimize blocking the view of product resting on a shelf. It is envisioned that a plurality of risers 10, which may be different in shape and appearance, can be used with a single front rail (retaining member) 8, perhaps when different products share a single shelve. The risers 10 can include clips or slides for holding product information, and/or may contain the components for electronically displaying information and/or automatic inventory monitoring and control. It is envisioned that the front rail 8 and/or risers 10 (and/or end caps and other parts of the shelves and display units) may be modified to include a housing for such information displays, monitors and controls. The front rail 8, risers 10 and/or other shelve and/or display components may cooperate and form parts of product information displays and/or electronic product inventory information and controls, inclusive of power supply and remote monitoring and communications. For example, products might have risers that alter sale terms to reflect product age, promotions, and changes in supply and demand, inter alia.

It should also be understood that the “large” apertures 63 in the underside of outer casings 6 and the apertures 53 in inner casings 5, reduce the amount of material required to construct the casings, reduce weight and related expense for roller assemblies 2, and therefore units 1. Apertures 63 and 53 also provide for passage of air and liquids to enhance ease of cleaning, reduce clogging, and minimize interference with temperature control of items placed on roller assemblies 2.

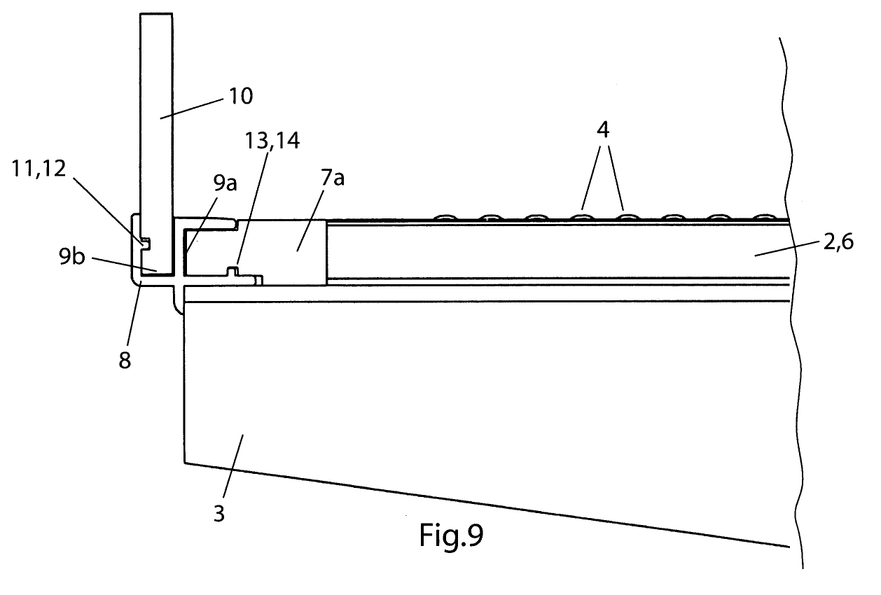

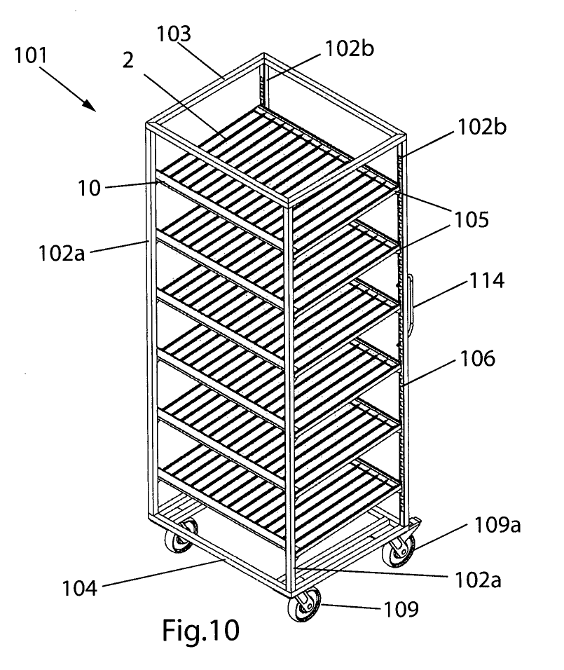

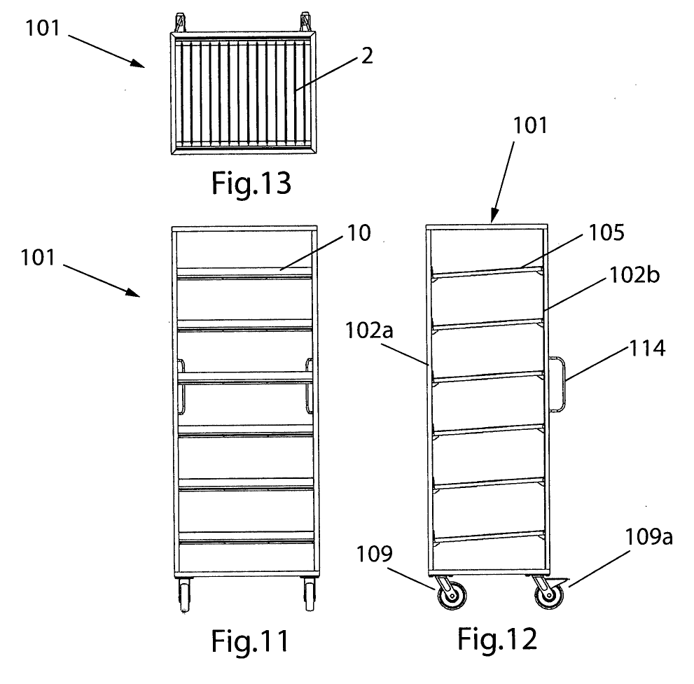

Whilst a preferred embodiment is described with reference to a unit 1 adapted to be secured to stationary conventional vertical shelf support members in a supermarket, it should be understood that unit 1, could be used on a mobile shelving assembly of the type having castor-wheels or the like. FIGS. 10-13 depict one such mobile shelving assembly (or trolley) 101, comprising a support frame having two front frame uprights 102a and two rear frame uprights 102b bolted to top frame section 103 and bottom frame section 104. Assembly 101 has a plurality of shelves 105, each is of which is height (vertically) adjustable by engagement with slots 106 in the frame uprights 102a, 102b. The support frame has ground engaging castor wheels 109 attached to bottom frame section 4. The rear castor wheels 109a are lockable.

Preferably mobile shelving assembly 101 is for the display of milk (or similar) products in the dairy section of a supermarket.

Each shelf 105, like that of the earlier described unit 1, is made up of an array of roller assemblies 2, which in this embodiment are depicted adjacent to each other.

The roller assemblies 2 are inclined downwardly from the rear to front of the shelf 105, so that product, such as milk in containers, which is loaded from the rear of the shelf, is moved to the front of the shelf 105 under the influence of gravity.

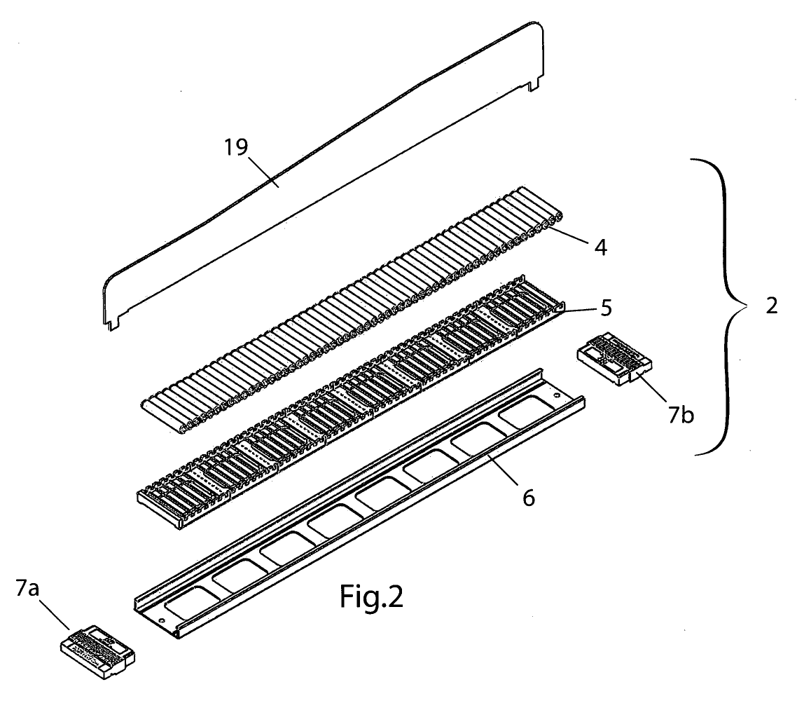

The apertures (cut-outs) 63, see FIGS. 2 and 5, on the underside of each outer casing 6 of each roller assembly 2 allow for moisture and liquids to pass through the roller assembly 2. This is important in a dairy display where accidental spillage of milk and other dairy products is a common occurrence.

Each shelf 105 has a clear front riser, similar to the earlier described riser 10 to ensure product visibility is kept to a maximum.

The support frame has two handles 114, each associated with a rear frame upright 102b. The handles 114 project rearwardly and inwardly so as to be accessible when the mobile shelving assembly 1 is aligned next to a like shelving assembly.

The bottom frame section (or base) 104 is adapted to receive a drip tray (not shown) that can be secured thereto to prevent or minimize liquids falling on the floor.

The advantage of the mobile shelving assembly 101 over conventional display units is that in addition to being loaded from the rear, the product is moved forwardly by the roller assemblies 2 towards the front under the influence of gravity, making it easy for shoppers to access the products supported thereon. Furthermore, as the roller assemblies 2 have a plurality of “large” apertures 63 in the underside 60 of outer casings 6, this ensures that moisture and liquids pass there through. This means that the spillage of milk and other dairy products and the like do not build up in the roller assemblies 2. The apertures 63 also allow for the shelving assembly 101 to be spray cleaned, as the water used for cleaning will pass there through.

Another advantage is that as the mobile shelving assembly 101 is on castor wheels 109, it can readily be moved around to allow the general area to be maintained and cleaned.

Furthermore a single display area may be made up of an array of such mobile shelving assemblies 1 adjacent to each other.

The roller assemblies 2 depicted in the abovementioned mobile shelving assembly 101 comprise a single track of rollers, which may for example be about 50 mm in width. However, in other embodiments the width may differ. Also, in other embodiments “dual roller tracks” may be employed where two sets of rollers each supported by separate inner casings are both mounted in a single outer casing.

Whilst the mobile shelving assembly 101 has been described with reference to its use in dairy display of a supermarket, the assembly (or trolley) of the present invention can be used for other uses.

One of the advantages of the above described roller assembly 2, is that it can be used in a display unit that is placed on top of a shelf, or as earlier mentioned can form part of the shelf as described with shelf unit 1 or mobile shelving unit 101.

The terms “comprising” and “including” (and their grammatical variations) as used herein are used in inclusive sense and not in the exclusive sense of “consisting only of”. Various materials, such as plastics and metals, can be used in constructing the present inventions. For example, plastics are known to one of ordinary skill in the art as being suitable for forming durable parts for engaging and supporting foods products and which can meet sterility and/or cleaning requirements. Shelves, rollers and overall display structures for use therewith in dispensing single serving containers will not require the strength required for heavier products, such as gallon size liquid containers. The present inventions contemplate use of injection molding, rotomolding, and extrusion techniques. Other embodiments and variations of the present inventions are contemplated and considered within the scope of applicant's exclusive rights as set forth in the following claims.

1. A roller assembly for use with a commodity display unit, said roller assembly comprising at least one set of parallel rollers mounted on an inner casing, wherein each roller of said parallel set of rollers is a stub roller with a stub at each end, and said inner casing has opposed side walls projecting from a base, each side wall having a series of notches at its upper free end for respectively receiving the stubs of said stub rollers, said inner casing with said rollers mounted thereon slidably engagable within an outer casing such that the stub rollers are restrained from being removed from their respective notches by two inwardly projecting upper flanges of said the outer casing, each upper flange projecting from a respective wall member of said outer casing, and wherein said inner casing is secured within said outer casing by two end caps, each slidable engagable with said outer casing at opposed ends thereof.

2. A roller assembly as claimed in claim 1, wherein said base of said inner casing having a plurality of apertures disposed therein.

3. A roller assembly as claimed in claim 1, wherein each roller and said inner casing is made of injection moulded plastic.

4. A roller assembly as claimed in claim 1, wherein said outer casing has a plurality of apertures disposed within its underside.

5. A roller assembly as claimed in claim 4, wherein said outer casing is of extruded metallic material and said apertures are cut-outs.

6. A roller assembly as claimed in claim 1, wherein each end cap is provided with a plurality of apertures.

7. A roller assembly as claimed in claim 6, wherein a divider element may be secured to said roller assembly by engaging with the end caps.

8. A roller assembly as claimed in claim 7, wherein said divider element engages with at least one of said plurality of apertures in each respective end cap.

9. A roller assembly as claimed in claim 1, wherein each end cap is made of injection moulded plastic.

10. A roller assembly as claimed in claim 1, wherein each end cap is secured to the outer casing by at least one threaded fastener.

11. A shelving display unit comprising an array of roller assemblies, each roller assembly being of the type claimed in claim 1, said array of roller assemblies disposed adjacent to one another, each of said roller assemblies having a first longitudinal axis inclined from the rear to the front of the unit such that product supported by said roller assemblies may travel by gravity feed from the rear to the front of the unit.

12. A shelving display unit as claimed in claim 11 wherein a front rail with a longitudinal channel of constant dimensions is slidably engageable with the end caps at the front of the unit.

13. A mobile shelving display unit comprising an array of roller assemblies, each roller assembly being of the type claimed in claim 1, said array of roller assemblies disposed adjacent to one another, each of said roller assemblies having a first longitudinal axis inclined from the rear to the front of the unit such that product supported by said roller assemblies may travel by gravity feed from the rear to the front of the unit.

14. A product display unit, said unit comprising at least one shelf, said at least one shelf comprising a retaining member for holding at least two roller track assemblies in alignment to form a planar product support surface, said retaining member comprising a first retaining channel for engaging a portion of at least two roller track assemblies, said retaining member comprising a second retaining channel for engaging at least one product stop member, wherein said second retaining channel is positioned with respect to said first retaining channel so as to direct a product stop member engaged with said second retaining channel to project above the plane of the product support surface formed by roller track assemblies engaged with said first retaining channel so as to be able to engage a product resting on a planar product support surface formed by at least two roller track assemblies aligned by engagement with said first retaining channel.

15. A retaining member for use in forming a shelf for a product display unit, said retaining member for holding at least two roller track assemblies in alignment to form a planar product support surface, said retaining member comprising a first retaining channel for engaging a portion of at least two roller track assemblies, said retaining member comprising a second retaining channel for engaging at least one product stop member, wherein said second retaining channel is positioned with respect to said first retaining channel so as to direct a product stop member engaged with said second retaining channel to project above the plane of the product support surface formed by roller track assemblies engaged with said first retaining channel so as to be able to engage a product resting on a planar product support surface formed by at least two roller track assemblies aligned by engagement with said first retaining channel.

16. The retaining member of claim 15, further comprising at least two roller track assemblies engaged therewith to form a shelving unit.

17. A mobile shelving assembly comprising a support frame supporting a plurality of spaced apart shelves, said support frame having a plurality of ground engaging wheels, at least one of said shelves having an array of inclined roller assemblies, each roller assembly having at least one set of parallel rollers mounted on an inner casing slidably engagable within an outer casing, wherein said outer casing has a plurality of apertures disposed within its underside.

18. A mobile shelving assembly as claimed in claim 17, wherein each roller of said parallel set of rollers is a stub roller with stubs on each side, said inner casing has opposed side walls, each side wall having a series of notches for respectively receiving the stubs of said stub rollers.

19. A mobile shelving assembly as claimed in claim 1, wherein said outer casing is of extruded material and said apertures are cut-outs.

20. A mobile shelving assembly as claimed in claim 17, wherein said array of inclined roller assemblies may be disposed adjacent to each other or adjusted at spaced apart increments.

21. A mobile shelving assembly as claimed in claim 17, wherein each of said shelves has a front riser.

22. A mobile shelving assembly as claimed in claim 17, wherein said support frame has a plurality of frame uprights, each frame upright has a plurality of holes therein for the vertical adjustment of shelf height.

23. A mobile shelving assembly as claimed in claim 22, wherein at least two handles project rearwardly and inwardly from said support frame, each handle associated with a respective frame upright.

24. A mobile shelving assembly as claimed in claim 22, wherein said plurality of frame uprights are bolted to top and bottom frame sections of said support frame.

25. A mobile shelving assembly as claimed in claim 17, wherein a drip tray can be removably secured to the base of said support frame.

26. A mobile shelving assembly as claimed in claim 17, wherein said ground engaging wheels are castor wheels.

27. A mobile shelving assembly as claimed in claim 26, wherein two of the castor wheels are lockable rear castor wheels.

28. A mobile shelving assembly as claimed in claim 17, wherein said assembly is used in the display of dairy products.
